(19) United States
(12) Patent Application Publication
(10) Pub. No.: US 2026/0134826 A1
(43) Pub. Date: May 14, 2026

(54) DISPLAY PANEL, DISPLAY SCREEN, AND ELECTRONIC DEVICE

(71) Applicant: GUANGDONG OPPO MOBILE TELECOMMUNICATIONS CORP., LTD., Dongguan (CN)

(72) Inventors: Changyu LIU, Dongguan (CN); Xiangyong KONG, Dongguan (CN)

(21) Appl. No.: 19/445,449

(22) Filed: Jan. 9, 2026

Related U.S. Application Data
(63) Continuation of application No. PCT/CN2024/134254, filed on Nov. 25, 2024.

(30) Foreign Application Priority Data
Nov. 30, 2023 (CN) 202311649511.1

(51) Int. Cl. G09G 3/32

(52) U.S. Cl. CPC G09G 3/32; G09G 2300/043; G09G 2300/0819; G09G 2310/0267; G09G 2320/0233

(57) ABSTRACT

A display panel, a display screen, and an electronic device are provided. The display panel includes a hole region, a winding line region surrounding the hole region, a display region surrounding at least part of the winding line region, and a non-display region. The display panel includes a first gate drive circuit located in the non-display region; the first gate drive circuit includes multiple first gate drive units cascaded; each first gate drive unit provides a first scan signal to two adjacent rows of multiple pixel circuits via two of multiple first signal transmission lines, respectively, and the first scan signal is capable of affecting gate potentials of drive transistors in the multiple pixel circuits; a portion of each first signal transmission line is located in the winding line region, and the portions of multiple first signal transmission lines located in the winding line region are independent of each other.

### CROSS REFERENCE TO RELATED APPLICATIONS

The present disclosure is a continuation of International Patent Application No. PCT/CN2024/134254, filed Nov. 25, 2024, which claims priority to Chinese Patent Application No. 202311649511.1, filed Nov. 30, 2023, both of which are herein incorporated by reference in their entireties.

### TECHNICAL FIELD

The present disclosure relates to the field of display technologies, and in particular to a display panel, a display screen, and an electronic device.

### BACKGROUND

The statements herein only provide background information related to the present disclosure and do not necessarily constitute the prior art.

A hole region configured to arrange functional components such as a camera, etc., a winding line region surrounding the hole region, and a display region surrounding at least part of the winding line region may be arranged on a display panel of an electronic device in the related art.

### SUMMARY

In a first aspect, a display panel is provided and includes: a hole region, a winding line region, a display region, and a non-display region; the winding line region surrounds the hole region, and the display region surrounds at least part of the winding line region; the display panel further includes a first gate drive circuit, and the first gate drive circuit is located in the non-display region on one side of the display region; the first gate drive circuit includes multiple first gate drive units cascaded; each of the multiple first gate drive units provides a first scan signal to two adjacent rows of multiple pixel circuits via two of multiple first signal transmission lines, respectively, and the first scan signal is capable of affecting gate potentials of drive transistors in the multiple pixel circuits; a portion of each of the multiple first signal transmission lines is located in the winding line region, and the portions of the multiple first signal transmission lines located in the winding line region are independent of each other.

In a second aspect, a display screen is provided and includes a cover plate and the display panel in the first aspect.

In a third aspect, an electronic device is provided and includes the display screen in the second aspect.

### BRIEF DESCRIPTION OF THE DRAWINGS

In order to more clearly illustrate the technical solutions in embodiments of the present disclosure or the related art, the drawings used in the description of embodiments or the related art will be briefly introduced below. Obviously, the drawings in the following description are only some embodiments of the present disclosure, and for those skilled in the art, other drawings may be obtained based on these drawings without creative effort.

FIG. 1 is a structural, schematic plan view of a display panel in the related art.

FIG. 2 is a structural, schematic plan view of a display panel according to some embodiments of the present disclosure.

FIG. 3 is a structural, schematic plan view of a region around a hole region in FIG. 2.

FIG. 4 is a structural, schematic plan view of a display panel according to some embodiments of the present disclosure.

FIG. 5 is a structural, schematic plan view of a display panel according to some embodiments of the present disclosure.

FIG. 6 is a structural, schematic view of a pixel circuit according to some embodiments of the present disclosure.

FIG. 7 is a structural, schematic view of a pixel circuit according to some embodiments of the present disclosure.

FIG. 8 is a structural, schematic plan view of a display panel according to some embodiments of the present disclosure.

FIG. 9 is a structural, schematic plan view of a display panel according to some embodiments of the present disclosure.

FIG. 10 is a structural, schematic plan view of a display panel according to some embodiments of the present disclosure.

FIG. 11 is a structural, schematic plan view of a display panel according to some embodiments of the present disclosure.

FIG. 12 is a structural, schematic view of a display screen according to some embodiments of the present disclosure.

FIG. 13 is a structural, schematic view of an electronic device according to some embodiments of the present disclosure.

### DETAILED DESCRIPTION

The technical solutions in some embodiments of the present disclosure will be clearly and completely described below with reference to the accompanying drawings in the embodiments of the present disclosure. Obviously, the described embodiments are only some embodiments of the present disclosure, and not all embodiments. All other embodiments obtained by those skilled in the art based on the embodiments of the present disclosure without creative efforts shall fall within the scope of the present disclosure.

Unless otherwise defined, all technical and scientific terms used herein have the same meanings as commonly understood by those skilled in the art of the present disclosure. The terms used herein in the description of the present disclosure are for the purpose of describing the embodiments only and are not intended to limit the present disclosure.

When describing positional relationships, unless otherwise specified, when one element such as a layer, film, or substrate is referred to as being “on” another element, it may be directly on another element or there may be an intermediate element. Furthermore, when a layer is referred to as being “under” another layer, it may be directly under another layer or there may be one or more intermediate elements. It should be understood that when a layer is referred to as being “between” two layers, it may be the only layer between the two layers or there may be one or more intermediate elements.

When using the terms “comprising”, “having”, and “containing” described herein, unless a clear limiting term such as “only” or “consisting of” is used, another component may be added. Unless stated to the contrary, a term in singular form may include a plural form and should not be understood as one.

It should be understood that although terms such as “first” and “second” may be used herein to describe various elements, these elements should not be limited by these terms. These terms are only used to distinguish one element from another. For example, without departing from the scope of the present disclosure, a first element may be referred to as a second element, and similarly, a second element may be referred to as a first element.

It should also be understood that when interpreting an element, although not explicitly described, the element is interpreted as including an error range, which should be within an acceptable deviation range of a specific value determined by those skilled in the art. For example, “about”, “approximately”, or “substantially” may mean within one or more standard deviations, and is not limited herein.

Furthermore, in the description, the phrase “schematic plan view” refers to a drawing when viewing a target portion from above, and the phrase “schematic cross-sectional view” refers to a drawing when viewing a cross-section taken by vertically cutting the target portion from the side.

Furthermore, the drawings are not drawn to scale 1:1, and the relative dimensions of the elements are drawn only exemplarily in the drawings and not necessarily to true scale.

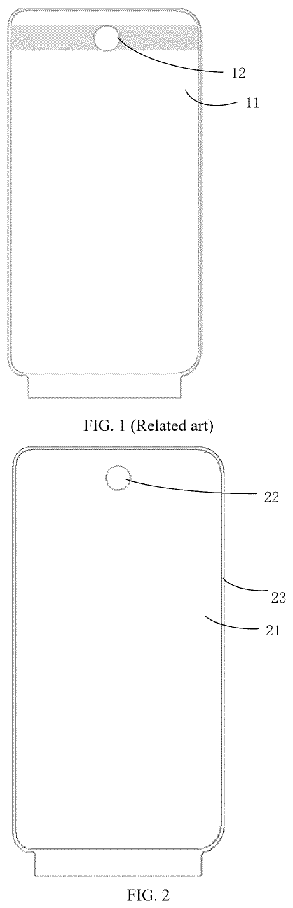

FIG. 1 is a structural, schematic plan view of a display panel in the related art. As shown in FIG. 1, the display panel in the related art includes a hole region 12, a winding line region (not shown), and a display region 11. The winding line region surrounds the hole region 12, and the display region 11 surrounds at least part of the winding line region. Structures such as a camera and a receiver, etc., may be arranged in the hole region 12 to reduce the area of the border region.

Due to the presence of the hole region 12, signal lines originally intended to be located in the hole region 12 are required to be arranged around the hole region and in the winding line region. There is a difference in wiring loading between the winding line region and the display region 11, leading to display non-uniformity in the display panel.

Based on the above technical problems, the inventors have found through research that adjusting the winding lines in the winding line region helps reduce the difference in wiring loading between the sub-screen region and the main screen region, thereby improving the display uniformity of the display panel. Based on this, the inventors have further developed the technical solutions of the embodiments of the present disclosure. The display panel provided by some embodiments of the present disclosure may include a hole region, a winding line region, a display region, and a non-display region. The winding line region surrounds the hole region, and the display region surrounds at least part of the winding line region. The display panel may include a first gate drive circuit, the first gate drive circuit is located in the non-display region on one side of the display region. Each first gate drive circuit may include multiple cascaded first gate drive units, the first gate drive units provides first scan signal to two adjacent rows of pixel circuits via two first signal transmission lines. The first scan signal is capable of affecting gate potentials of drive transistors in the pixel circuits. A portion of each first signal transmission lines is located in the winding line region, and portions of the multiple first signal transmission lines located in the winding line region are independent of each other.

By adopting the above technical solutions, the wiring distribution of the first signal transmission lines in the display region is similar to the wiring distribution of the first signal transmission lines in the winding line region, thereby reducing the difference in the loading of the first signal transmission lines between the display region and the winding line region. Since the first signal transmission lines may transmit the first scan signal, and the first scan signal is capable of affecting the gate potentials of the drive transistors in the pixel circuits, the difference in the gate potentials of the drive transistors between the winding line region and the display region may be reduced, thereby improving display uniformity.

The above is the core idea of the present disclosure. The technical solutions in some embodiments of the present disclosure will be clearly and completely described below with reference to the accompanying drawings in the embodiments of the present disclosure. Based on the embodiments of the present disclosure, all other embodiments obtained by those skilled in the art without creative efforts shall fall within the scope of the present disclosure.

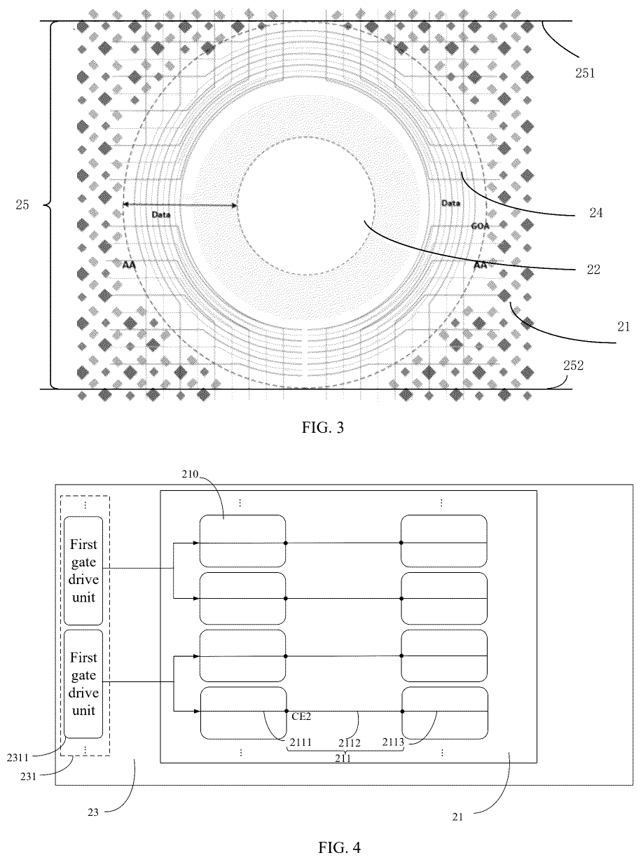

FIG. 2 is a structural, schematic plan view of a display panel according to some embodiments of the present disclosure. FIG. 3 is a structural, schematic plan view of a region around a hole region in FIG. 2. FIG. 4 is a structural, schematic plan view of a display panel according to some embodiments of the present disclosure. As shown in FIGS. 2-3, the display panel provided by some embodiments of the present disclosure may include: a hole region 22, a winding line region 24, a display region 21, and a non-display region 23. The winding line region 24 surrounds the hole region 22, and the display region 21 surrounds at least part of the winding line region 24. Winding lines may be arranged in the winding line region 24 to avoid the hole region 22 and connect signal lines on both sides of the winding line region 24. As shown in FIG. 4, the display panel further may include a first gate drive circuit 231, and the first gate drive circuit 231 is located in the non-display region 23 on one side of the display region 21.

The first gate drive circuit 231 may include multiple cascaded first gate drive units 2311. The term “cascaded” may be understood as being connected level by level along the column direction, with the level number increasing from top to bottom.

Each first gate drive unit 2311 provides first scan signal to two rows of pixel circuits 210 via two first signal transmission lines 211, respectively. Exemplarily, the i^{th} level first gate drive unit 2311 provides the first scan signal to the (2i−1)^{th} and 2i^{th} rows of pixel circuits 210 via two first signal transmission lines 211, respectively, where i is a positive integer greater than or equal to 1. Thus, each first gate drive unit 2311 adopts a one-drive-two design, which reduces the number of first gate drive units 2311 in the non-display region 23, thereby reducing the area occupied by the gate drive units in the border and achieving a narrow border.

The first scan signal is capable of affecting the gate potentials of the drive transistors in the pixel circuits 210. The first scan signal may be provided to threshold compensation control terminals in the pixel circuits 210 to control the threshold compensation process and the data writing process of the drive transistors.

In some embodiments of the present disclosure, a portion of each first signal transmission line 211 is located in the winding line region 24, and portions the first signal transmission lines 211 located in the winding line region 24 are independent of each other. In the related art, portions of the first signal transmission lines located in the winding line region are shared, resulting in significant differences in the wiring manner between the winding line region and the display region, leading to display non-uniformity in the display panel.

However, in the display panel of some embodiment of the present disclosure, the portions of the first signal transmission lines 211 located in the winding line region 24 are independent of each other, so that the wiring distribution of the first signal transmission lines 211 in the display region 21 is similar to the wiring distribution of the first signal transmission lines 211 in the winding line region 24, thereby reducing the difference in loading of the first signal transmission lines 211 and the second signal transmission lines between the display region 21 and a target region 25. The target region 25 is the region between a first tangent line 251 and a second tangent line 252, the first tangent line 251 and the second tangent line 252 are different line segments, both extending in the row direction and tangent to the winding line region 24, respectively. The first signal transmission lines 211 may transmit the first scan signal, and the first scan signal is capable of affecting the gate potentials of the drive transistors in the pixel circuits 210, thereby reducing the difference in the gate potentials of the drive transistors between the target region 25 and the display region 21 and improving display uniformity.

The above display panel may include a hole region 22, a winding line region 24, a display region 21, and a non-display region 23. The winding line region 24 surrounds the hole region 22, and the display region 21 surrounds at least part of the winding line region 24; the display panel may include a first gate drive circuit 231, the first gate drive circuit 231 is located in the non-display region 23 on one side of the display region 21. The first gate drive circuit 231 may include multiple cascaded first gate drive units 2311. Since each first gate drive unit 2311 provides first scan signal to two rows of pixel circuits 210 via two first signal transmission lines 211, respectively, and the portions of the first signal transmission lines 211 located in the winding line region 24 are independent of each other, there is no shared line segment in the first signal transmission lines 211 in the winding line region 24, so that the wiring distribution of the first signal transmission lines 211 in the display region 21 is similar to the wiring distribution of the first signal transmission lines 211 in the winding line region 24. Therefore, the difference in the loading of the first signal transmission lines 211 between the display region 21 and the winding line region 24 may be reduced. The first signal transmission lines 211 may transmit the first scan signal, and the first scan signal is capable of affecting the gate potentials of the drive transistors in the pixel circuits 210, thereby reducing the difference in the gate potentials of the drive transistors between the target region 25 and the display region 21 and improving display uniformity.

In some embodiments, as shown in FIG. 4, each first signal transmission line 211 in the target region may include a first A line segment 2111, a first winding line 2112, and a first B line segment 2113 electrically connected in sequence. The first winding line 2112 is located in the winding line region 24, and the first A line segment 2111 and the first B line segment 2113 are located in the display region 21 on two sides of the winding line region 24, respectively, so that the first A line segment 2111 is connected to the first B line segment 2113 via the first winding line 2112, and the first scan signal output by the first gate drive units 2311 may be transmitted to the pixel circuits 210 on both sides of the winding line region 24.

FIG. 5 is a structural, schematic plan view of a display panel according to some embodiments of the present disclosure. As shown in FIG. 5, the display panel may include a second gate drive circuit 232, the second gate drive circuit 232 is located in the non-display region 23 on another side of the display region 21, i.e., the first gate drive circuit 231 and the second gate drive circuit 232 are located in the non-display region 23 on two sides of the display region 21, respectively.

The second gate drive circuit 232 may include multiple cascaded second gate drive units 2321.

Each second gate drive unit 2321 of the same level as the first gate drive unit 2311 provides second scan signal to two rows of pixel circuits 210 via two second signal transmission lines, respectively. Exemplarily, the i^{th} level first gate drive unit 2311 provides the first scan signal to the (2i−1)^{th} and 2i^{th} rows of pixel circuits 210 via two first signal transmission lines 211, respectively, the i^{th} level second gate drive unit 2321 provides the second scan signal to the (2i−1)^{th} and 2i^{th} rows of pixel circuits 210 via two second signal transmission lines, respectively, where i is a positive integer greater than or equal to 1. Thus, both the first gate drive units 2311 and the second gate drive units 2321 adopt a 1-drive-2 design, which reduces the number of first gate drive units 2311 and second gate drive units 2321 in the non-display region 23, thereby reducing the area occupied by the gate drive units in the border and achieving a narrow border.

The second scan signal is different from the first scan signal and is capable of affecting the gate potentials of the drive transistors in the pixel circuit 210. The second scan signal may be provided to initialization control terminals to control the initialization process of the gate potentials of the drive transistors, and the initialization control terminals are configured to drive the gate potentials of the drive transistors in the pixel circuits 210.

A portion of each the second signal transmission lines 212 is located in the winding line region 24, and portions of the second signal transmission lines 212 located in the winding line region 24 are independent of each other. In the related art, portions of the second signal transmission lines located in the winding line region are shared, resulting in significant differences in the wiring manner between the winding line region and the display region, leading to display non-uniformity in the display panel.

By adopting the above configuration in this embodiment, the wiring distribution of the second signal transmission lines 212 in the display region 21 is similar to the wiring distribution of the second signal transmission lines 212 in the winding line region 24, thereby reducing the difference in the loading of the second signal transmission lines 212 between the display region 21 and the winding line region 24. Additionally, the second signal transmission lines 212 may transmit the second scan signal, and the second scan signal is capable of affecting the gate potentials of the drive transistors in the pixel circuits 210, thereby reducing the difference in the gate potentials of the drive transistors between the target region 25 and the display region 21 and improving display uniformity.

In some embodiments, as shown in FIG. 5, each of the second signal transmission lines in the target region 25 may include a second A line segment 2121, a second winding line 2122, and a second B line segment 2123 electrically connected in sequence. The second winding line 2122 is located in the winding line region 24, and the second A line segment 2121 and the second B line segment 2123 are located in the display region 21 on two sides of the winding line region 24, respectively, so that the second A line segment 2121 is connected to the second B line segment 2123 via the second winding line 2122, and the second scan signal output by the second gate drive units 2321 may be transmitted to the pixel circuits 210 on both sides of the winding line region 24.

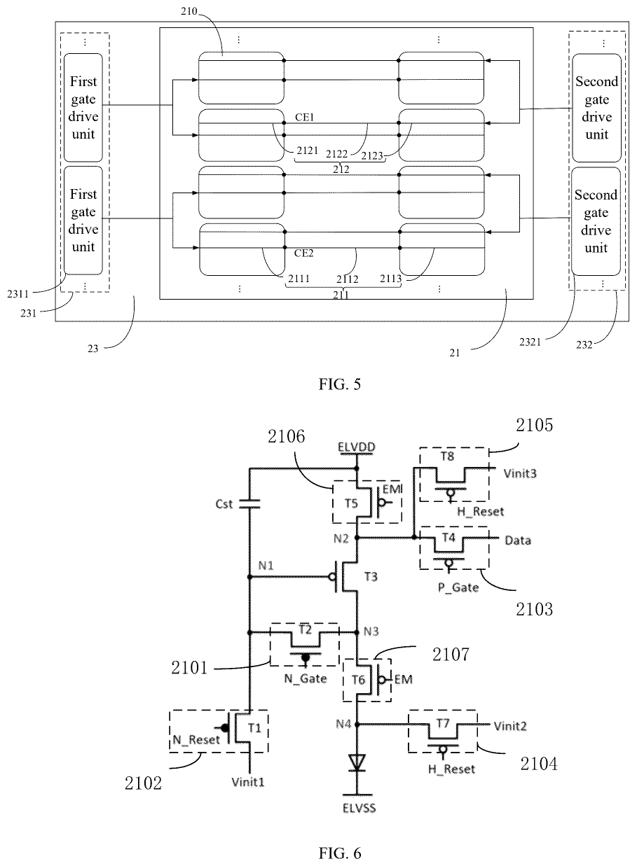

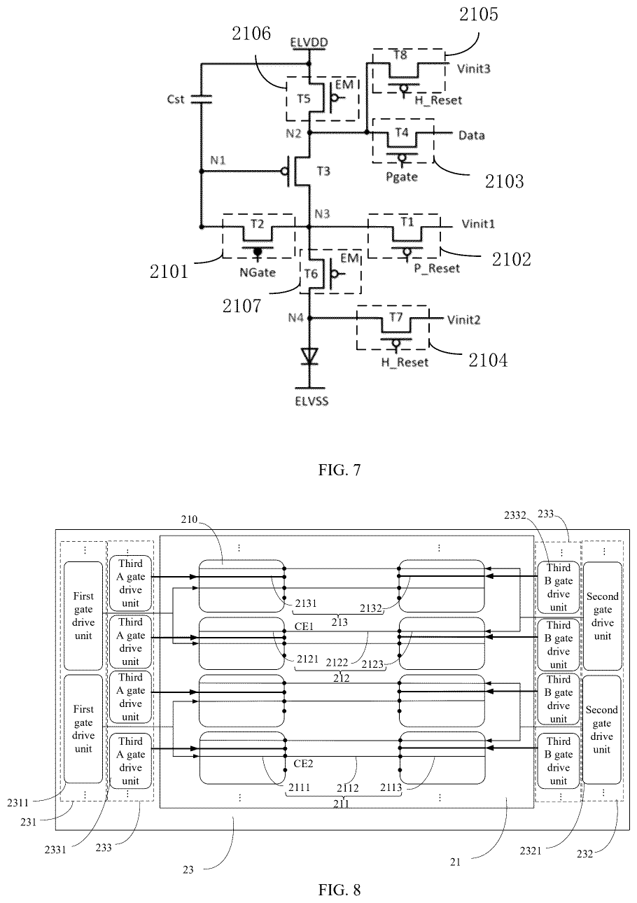

FIG. 6 is a structural, schematic view of a pixel circuit according to some embodiments of the present disclosure, and FIG. 7 is a structural, schematic view of a pixel circuit according to some embodiments of the present disclosure. In some embodiments, as shown in FIGS. 6-7, the pixel circuit 210 may include: a drive transistor T3, a storage capacitor Cst, a threshold compensation module 2101, and a first initialization module 2102. In FIG. 6, N_Gate is the first scan signal, N_Reset is the second scan signal, P_Gate is the third scan signal, H_Reset is the fourth scan signal, EM is the light emission control signal, ELVDD is the first power signal, ELVSS is the second power signal. In FIG. 7, NGate is the first scan signal, P_Reset is the second scan signal, PGate is the third scan signal, H_Reset is the fourth scan signal, EM is the light emission control signal, ELVDD is the first power signal, ELVSS is the second power signal.

The drive transistor T3 is configured to provide a drive current to a light-emitting element.

A first terminal of the storage capacitor Cst is configured to receive the first power signal, and a second terminal of the storage capacitor Cst is connected to the gate of the drive transistor T3.

A first terminal of the threshold compensation module 2101 is connected to the second electrode of the drive transistor T3, a second terminal of the threshold compensation module 2101 is connected to the gate of the drive transistor T3, a control terminal of the threshold compensation module 2101 is connected to a second signal transmission line, and a control terminal of the threshold compensation module 2101 is configured to receive a first scan signal.

A first terminal of the first initialization module 2102 is configured to receive a first initialization signal, a second terminal of the first initialization module 2102 is connected to the gate of the drive transistor T3 or the first terminal of the threshold compensation module 2101, a control terminal of the first initialization module 2102 is connected to a first signal transmission line 211, and the control terminal of the first initialization module 2102 is configured to receive a second scan signal.

In a case where the second terminal of the first initialization module 2102 is connected to the gate of the drive transistor T3, in a first initialization phase, the first initialization module 2102 turns on in response to the second scan signal, the first initialization signal is written to the gate of the drive transistor T3 via the first terminal and the second terminal of the first initialization module 2102, initializing the gate potential of the drive transistor T3.

In a case where the second terminal of the first initialization module 2102 is connected to the first terminal of the threshold compensation module 2101, in the first initialization phase, the first initialization module 2102 turns on in response to the second scan signal, the threshold compensation module 2101 turns on in response to the first scan signal, and the first initialization signal is written to the gate of the drive transistor T3 via the first terminal and the second terminal of the first initialization module 2102 and the first terminal and the second terminal of the threshold compensation module 2101, initializing the gate potential of the drive transistor T3.

In a data writing phase, the threshold compensation module 2101 turns on in response to the first scan signal, and the data signal is written to the gate of the drive transistor T3 via the first terminal and the second terminal of the threshold compensation module 2101.

Both the second scan signal and the first scan are capable of affecting the gate potentials of the drive transistors T3 in the pixel circuits 210. Therefore, reducing the difference in the loading of the first signal transmission lines 211 and the second signal transmission lines between the display region 21 and the winding line region 24 may reduce the difference in the gate potentials of the drive transistors T3 between the winding line region 24 and the display region 21, thereby improving display uniformity.

In some embodiments, as shown in FIG. 5, the portions of the first signal transmission lines 211 located in the winding line region 24 are located in a layer different from the portions of the second signal transmission lines 212 located in the winding line region 24, i.e., the second winding lines 2122 are located in a layer different from the first winding lines 2112. In FIG. 5, CE1 and CE2 represent different gate layers.

The second winding lines 2122 are located in a layer different from the first winding lines 2112, thereby avoiding excessive density of winding lines in the same gate layer, providing space for compressing the border region corresponding to the hole region 22, helping narrow the border corresponding to the hole region 22, and improving the screen-to-body ratio of the display panel.

FIG. 8 is a structural, schematic plan view of a display panel according to some embodiments of the present disclosure. As shown in FIG. 8, in some embodiments, the display panel may include a third gate drive circuit 233. The third gate drive circuit 233 may include multiple cascaded third A gate drive units 2331 and multiple cascaded third B gate drive units 2332. The third A gate drive units 2331 and the third B gate drive units 2332 are located in the non-display region 23 on two sides of the display region 21, respectively.

Each third A gate drive unit 2331 and one third B gate drive unit 2332 arranged at the same level provide a third scan signal to the same row of pixel circuits 210 via a third signal transmission line. The third scan is capable of affecting the data writing of the pixel circuits 210. Exemplarily, the i^{th} level third A gate drive unit 2331 and the i^{th} level third B gate drive unit 2332 provide the third scan signal to the i^{th} row of pixel circuits 210 via a third signal transmission line.

The display region 21 may be divided into two display sub-regions, and the two display sub-regions are close to the non-display region 23 on two sides of the display region 21, respectively. The third A gate drive units 2331 provide third scan signal to the pixel circuits 210 in the display sub-region close to the third A gate drive units 2331. The third B gate drive units 2332 provide the third scan signal to the pixel circuits 210 in another display sub-region. Thus, two-side driving may be achieved through the third A gate drive units 2331 and the third B gate drive units 2332, thereby reducing the transmission distance of the third scan signal, helping reduce the impact of signal line voltage drop, and improving display uniformity.

In some embodiments, as shown in FIGS. 6-7, the pixel circuit 210 may include a data writing module 2103. A first terminal of the data writing module 2103 is configured to receive a data signal, a second terminal of the data writing module 2103 is connected to the first electrode of the drive transistor T3, and a control terminal of the data writing module 2103 is configured to receive the third scan signal.

In the data writing phase, the data writing module 2103 turns on in response to the third scan signal, the threshold compensation module 2101 turns on in response to the first scan signal, and the data signal is written to the gate of the drive transistor T3 via the first terminal and the second terminal of the data writing module 2103, the first terminal and the second electrode of the drive transistor T3, and the first terminal and the second terminal of the threshold compensation module 2101. The third scan signal output by the third gate drive circuit 233 controls the data writing phase of the pixel circuit 210.

In the above embodiments, the third gate drive circuits 233 may include multiple cascaded third A gate drive units 2331 and multiple cascaded third B gate drive units 2332. The third A gate drive units 2331 and the third B gate drive units 2332 are located in the non-display region 23 on two sides of the display region 21, respectively. Each third A gate drive unit 2331 and one third B gate drive unit 2332 arranged at the same level provide the third scan signal to the same row of pixel circuits 210 via a third signal transmission line. Thus, tow-side driving may be achieved through the third A gate drive units 2331 and the third B gate drive units 2332. Both the third A gate drive units 2331 and the third B gate drive units 2332 adopt a one-drive-one design, thereby maximizing the reduction of the difference in the loading of the third signal transmission lines between the winding line region 24 and the display region 21, helping reduce the difference in the gate potentials of the drive transistors T3 between the winding line region 24 and the display region 21, improving display uniformity.

In some embodiments, as shown in FIG. 8, each third signal transmission line in the target region 25 may include a third A line segment 2131 connected to a third A gate drive unit 2331 and a third B line segment 2132 connected to a third B gate drive unit 2332. The third A line segment 2131 and the third B line segment 2132 are located in the display region 21 on two sides of the winding line region 24, respectively.

Each third A gate drive unit 2331 is connected to a third A line segment 2131, and each third B gate drive unit 2332 is connected to a third B line segment 2132. Thus, each third A gate drive unit 2331 may provide the third scan signal to the pixel circuits 210 on the side of the winding line region 24 close to the third A gate drive unit 2331 via the third A line segment 2131, and the third B gate drive unit 2332 may provide the third scan signal to the pixel circuits 210 on another side of the winding line region 24 via the third B line segment 2132. Thus, for a specific display panel (e.g., a display panel where the hole region 22 does not need to emit light), there is no need to connect the third A line segment 2131 and the third B line segment 2132 via a winding line, helping reduce the number of winding lines in the winding line region 24, helping narrow the border corresponding to the hole region 22, and improving the screen-to-body ratio of the display panel.

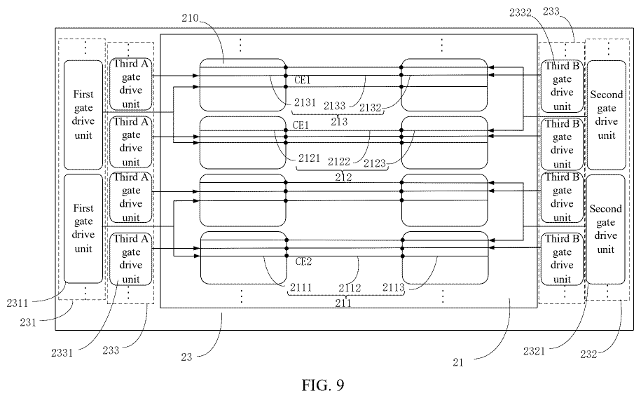

FIG. 9 is a structural, schematic plan view of a display panel according to some embodiments of the present disclosure. In some embodiments, as shown in FIG. 9, each third signal transmission line in the target region 25 may include a third winding line 2133 respectively connected to the third A line segment 2131 and the third B line segment 2132, and the third winding line 2133 is located in the winding line region 24.

For a display panel where the hole region 22 serves as a sub-screen region, i.e., the hole region 22 is required to emit light, the third winding line 2133 is required to connect the third A line segment 2131 and the third B line segment 2132, thereby providing the third scan signal to the pixel circuits 210 in the hole region 22, supporting light emission in the hole region 22.

In some embodiments, as shown in FIG. 9, the portions of the first signal transmission lines 211 located in the winding line region 24 may be located in a layer different from the portions of the third signal transmission lines 213 located in the winding line region 24. That is, the third winding lines 2133 may be located in a layer different from and the first winding lines 2112, and may be located in the same layer as the second winding lines 2122.

In the related art, the first scan signal is provided to a type of transistors, and the third scan signal is provided to another type of transistors, so that the signal lines providing the first scan signal are located in a layer different from the signal lines providing the third scan signal.

In this embodiment, the third winding lines 2133 are arranged in a layer different from the first winding lines 2112, are arranged in the same layer as the second winding lines 2122, thereby avoiding excessive changes in the manufacturing process of the display panel, and reducing the cost of process improvements.

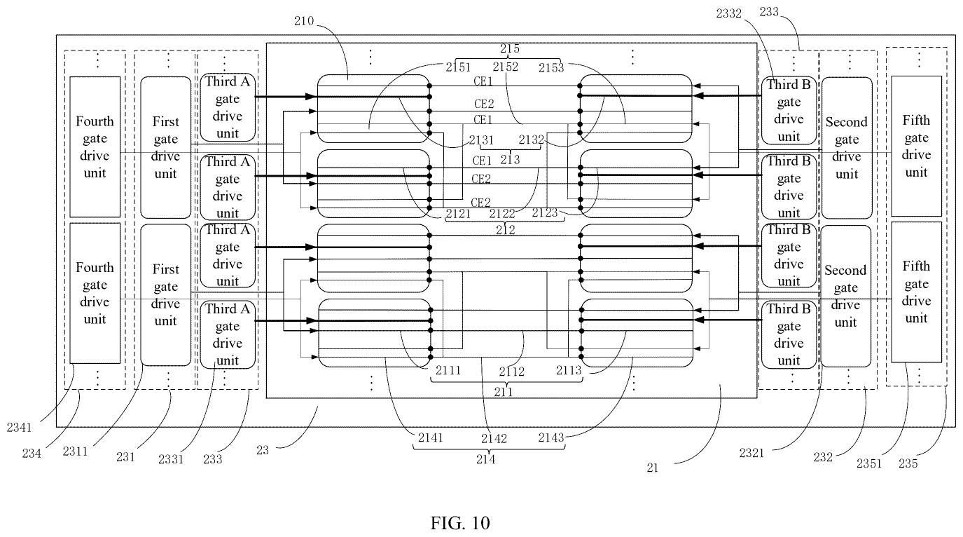

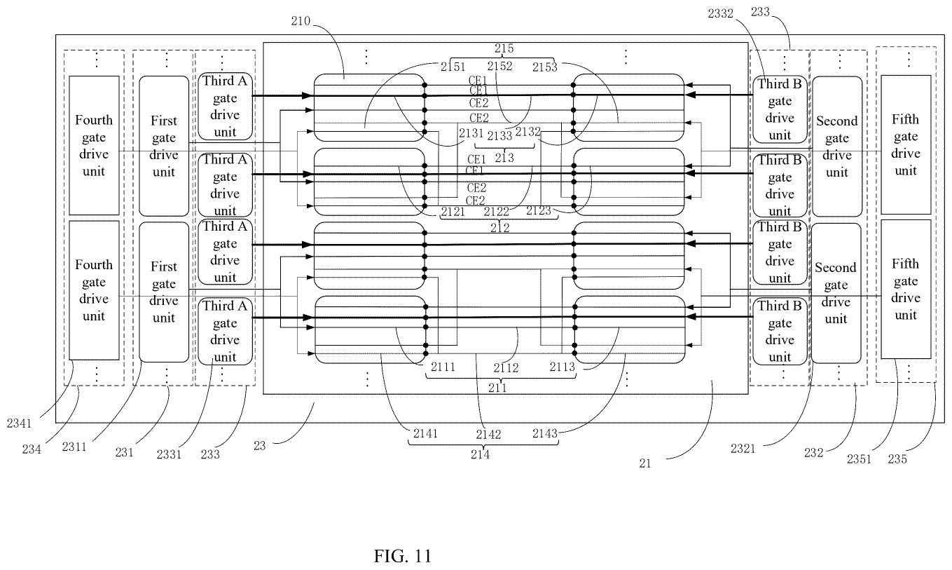

FIG. 10 is a structural, schematic plan view of a display panel according to some embodiments of the present disclosure, and FIG. 11 is a structural, schematic plan view of a display panel according to some embodiments of the present disclosure. In some embodiments, as shown in FIGS. 10-11, the non-display region 23 may include a fourth gate drive circuit 234. The fourth gate drive circuit 234 may be located in the non-display region 23 on the same side of the display region 21 as the first gate drive circuit 231. The fourth gate drive circuit 234 may include multiple cascaded fourth gate drive units 2341.

Each fourth gate drive unit 2341 provides a fourth scan signal to two rows of pixel circuits 210 via two fourth signal transmission lines, respectively. Exemplarily, the i^{th} level fourth gate drive unit 2341 provides the fourth scan signal to the (2i−1)^{th} and 2i^{th} rows of pixel circuits 210 via two fourth signal transmission lines, respectively. Thus, each fourth gate drive unit 2341 adopts a one-drive-two design, thereby reducing the number of fourth gate drive units 2341 in the non-display region 23, reducing the area occupied by the gate drive units in the border, and achieving a narrow border.

The fourth scan signal is capable of affecting the first electrode potentials of the drive transistors in the pixel circuits 210 and the anode potentials of the light-emitting elements. The fourth scan signal may control the initialization process of the first electrode potentials of the drive transistors and the initialization process of the anode potentials of the light-emitting elements. Therefore, the fourth scan signal may control the initialization process of the first electrode potentials of the drive transistors and the initialization process of the anode potentials of the light-emitting elements via the fourth gate drive units 2341.

In some embodiments, as shown in FIGS. 10-11, each the fourth signal transmission line 214 in the target region 25 may include a fourth A line segment 2141 and a fourth B line segment 2143. Each fourth gate drive unit 2341 is connected to two fourth signal transmission lines 214, one of the two fourth signal transmission lines 214 may include a fourth winding line 2142, and each two fourth A line segments 2141 are connected to the two fourth B line segments 2143 via one fourth winding line 2142, respectively. The fourth winding lines 2142 are located in the winding line region 24, and the fourth A line segments 2141 and the fourth B line segments 2143 are located in the display region 21 on two sides of the winding line region 24, respectively.

The fourth scan signal is capable of affecting the first electrode potentials of the drive transistors and the anode potentials of the light-emitting elements in the pixel circuits 210, and the fourth scan signal has low impact on the gate potentials of the drive transistors, so that there is a difference in the loading of the fourth signal transmission lines between the target region 25 and a normal region (the display region 21 excluding the target region 25). Each two fourth A line segments 2141 may be connected to two fourth B line segments 2143 via one fourth winding line 2142, i.e., each two fourth signal transmission lines may share one fourth winding line 2142, thereby reducing the number of winding lines in the winding line region 24, helping narrow the border corresponding to the hole region 22, and improving the screen-to-body ratio of the display panel.

In some embodiments, as shown in FIGS. 10-11, one of the second winding lines 2122 and the first winding lines 2112 are located in the same layer as the fourth winding lines 2142, and another of the second winding lines 2122 and the first winding lines 2112 are located in a different layer from the fourth winding lines 2142.

One of the second winding lines 2122 and the first winding lines 2112 are located in the same layer as the fourth winding lines 2142, and another of the second winding lines 2122 and the first winding line s 2112 are located in a different layer from the fourth winding lines 2142, thereby avoiding excessive density of winding lines in the same gate layer, thereby providing space for compressing the border region corresponding to the hole region 22, helping narrow the border corresponding to the hole region 22, and improving the screen-to-body ratio of the display panel.

In some embodiments, as shown in FIGS. 10-11, the non-display region 23 may include a fifth gate drive circuit 235. The fifth gate drive circuit 235 may be located in the non-display region 23 on the same side of the display region 21 as the second gate drive circuit 232. The fifth gate drive circuit 235 may include multiple cascaded fifth gate drive units 2351.

Each fifth gate drive unit 2351 provides light emission control signal to two rows of pixel circuits 210 via two fifth signal transmission lines, respectively. Exemplarily, the i^{th} level fifth gate drive unit 2351 provides the light emission control signal to the (2i−1)^{th} and 2i^{th} rows of pixel circuits 210 via two fifth signal transmission lines, respectively.

Each fifth gate drive unit 2351 adopts a one-drive-tow design, thereby reducing the number of fifth gate drive units 2351 in the non-display region 23, reducing the area occupied by the gate drive units in the border, and achieving a narrow border.

The light emission control signal is capable of affecting the light emission of the light-emitting elements. The light emission control signal may control the process of the pixel circuits 210 driving the light-emitting elements to emit light, thereby achieving light emission control through the fifth gate drive units 2351.

In some embodiments, as shown in FIGS. 10-11, each fifth signal transmission line in the target region 25 may include a fifth A line segment 2151 and a fifth B line segment 2153. Each fifth gate drive unit 2351 is connected to two fifth signal transmission lines 215, one of the two fifth signal transmission lines 215 may include a fifth winding line 2152, and each two fifth A line segments 2151 are connected to the two fifth B line segments 2153 via one fifth winding line 2152, respectively. The fifth winding lines 2152 are located in the winding line region 24, and the fifth A line segments 2151 and the fifth B line segments 2153 are located in the display region 21 on two sides of the winding line region 24, respectively.

The light emission control signal is capable of affecting the light emission of the light-emitting elements, and the light emission control signal has a low impact on the data writing process, so that there is a difference in the loading of the fifth signal transmission lines between the target region 25 and a normal region (the display region 21 excluding the target region 25). Each two fifth A line segments 2151 may be connected to two fifth B line segments 2153 via one fifth winding line 2152, i.e., each two fifth signal transmission lines may share one fifth winding line 2152, thereby reducing the number of winding lines in the winding line region 24 is, helping narrow the border corresponding to the hole region 22 and improving the screen-to-body ratio of the display panel.

In some embodiments, as shown in FIGS. 6-7, the pixel circuit 210 may include: a second initialization module 2104, a third initialization module 2105, a first light emission control module 2106, and a second light emission control module 2107.

A first terminal of the second initialization module 2104 is configured to receive a second initialization signal, a second terminal of the second initialization module 2104 is connected to the gate of the drive transistor T3, and a control terminal of the second initialization module 2104 is configured to receive the fourth scan signal.

In a second initialization phase, the second initialization module 2104 turns on in response to the fourth scan signal, and the second initialization signal is written to the anode of the light-emitting element via the first terminal and the second terminal of the second initialization module 2104, initializing the anode potential of the light-emitting element.

A first terminal of the third initialization module 2105 is configured to receive a third initialization signal, a second terminal of the third initialization module 2105 is connected to the first electrode of the drive transistor T3, and a control terminal of the third initialization module 2105 is configured to receive the fourth scan signal.

Before and after the data writing phase, the third initialization module 2105 turns on in response to the fourth scan signal, and the third initialization signal is written to the first electrode of the drive transistor T3 via the first terminal and the second terminal of the third initialization module 2105, initializing the first electrode potential of the drive transistor T3.

A first terminal of the first light emission control module 2106 is configured to receive the first power signal, a second terminal of the first light emission control module 2106 is connected to the first electrode of the drive transistor T3, and a control terminal of the first light emission control module 2106 is configured to receive the light emission control signal.

A first terminal of the second light emission control module 2107 is connected to the second electrode of the drive transistor T3, a second terminal of the second light emission control module 2107 is connected to the anode of the light-emitting element, and a control terminal of the second light emission control module 2107 is configured to receive the light emission control signal.

In a light emission phase, the first light emission control module 2106 and the second light emission control module 2107 turn on in response to the light emission control signal, and the drive transistor T3 provides a drive current to the light-emitting element, driving the light-emitting element to emit light.

The fourth scan signal and the light emission control signal have a low impact on the data writing process, so that the fourth transmission lines in the target region 25 may be different from the fourth transmission lines in the normal area, and the loading of the fifth signal transmission lines in the target region 25 may be different from the loading of the fifth signal transmission lines in the normal area. Therefore, each two fourth A line segments 2141 may be connected to two fourth B line segments 2143 via one fourth winding line 2142, i.e., each two fourth signal transmission lines may share one fourth winding line 2142, each two fifth A line segments 2151 may be connected to two fifth B line segments 2153 via one fifth winding line 2152, i.e., each two fifth signal transmission lines may share one fifth winding line 2152, thereby reducing the number of winding lines in the winding line region 24 is, helping narrow the border corresponding to the hole region 22, and improving the screen-to-body ratio of the display panel.

In some embodiments, as shown in FIGS. 10-11, one of the second winding lines 2122 and the first winding lines 2112 are located in the same layer as the fifth winding lines 2152, and another of the second winding lines 2122 and the first winding lines 2112 are located in a different layer from the fifth winding lines 2152.

One of the second winding lines 2122 and the first winding lines 2112 are located in the same layer as the fifth winding lines 2152, and another of the second winding lines 2122 and the first winding lines 2112 are located in a different layer from the fifth winding lines 2152, thereby avoiding excessive density of winding lines in the same gate layer, providing space for compressing the border region corresponding to the hole region 22, helping narrow the border corresponding to the hole region 22, and improving the screen-to-body ratio of the display panel.

In some embodiments, the display panel may include a substrate and a drive circuit layer. The drive circuit layer may include a first gate layer CE1 and a second gate layer CE2. The second winding lines 2122 are located in the first gate layer CE1, and the first winding lines 2112 are located in the second gate layer CE2. In this way, the second winding line 2122 and the first winding line 2112 are located in different layers, thereby avoiding excessive density of winding lines in the same layer, providing space for compressing the border region corresponding to the hole region 22, helping narrow the border corresponding to the hole region 22, and improving the screen-to-body ratio of the display panel.

Based on the above embodiments, as shown in FIG. 10, in one example, in a case where each third signal transmission line in the target region 25 includes a third A line segment 2131 connected to a third A gate drive unit 2331 and a third B line segment 2132 connected to a third B gate drive unit 2332. The third A line segment 2131 and the third B line segment 2132 are located in the display region 21 on two sides of the winding line region 24, respectively, i.e., the third A line segment 2131 and the third B line segment 2132 are not connected via a winding line. In this way, the second winding lines 2122 are located in the first gate layer CE1, the first winding lines 2112 are located in the second gate layer CE2, and the fourth winding lines 2142 and the fifth winding lines 2152 are located in different layers. For example, the fourth winding lines 2142 are located in the first gate layer CE1, and the fifth winding lines 2152 are located in the second gate layer CE2. For another example, the fifth winding lines 2152 are located in the first gate layer CE1, and the fourth winding lines 2142 are located in the second gate layer CE2. Since the numbers of the second winding lines 2122 are substantially the same as the numbers of the first winding lines 2112, and the numbers of the fourth winding line 2142 are substantially the same as the fifth winding line 2152, the above arrangement may make the distribution of winding lines in the gate layers relatively uniform, thereby helping narrow the border corresponding to the hole region 22.

Based on the above embodiments, as shown in FIG. 11, in another example, in a case where each third signal transmission line in the target region 25 include a third A line segment 2131, a third winding line 2133, and a third B line segment 2132 electrically connected in sequence, and the third winding line 2133 is located in the winding line region 24. In this way, the second winding lines 2122 and the third winding lines 2133 are located in the first gate layer CE1, and the first winding lines 2112, the fourth winding lines 2142, and the fifth winding lines 2152 are located in the second gate layer CE2. Since the numbers of the second winding line 2122 are substantially the same as the numbers of the first winding lines 2112, and the sum of the numbers of the fourth winding lines 2142 and the fifth winding lines 2152 is substantially the same as the number of the third winding lines 2133, the above arrangement may make the distribution of winding lines in the gate layers relatively uniform, thereby helping narrow the border corresponding to the hole region 22.

In some embodiments, the display panel may include a substrate and a drive circuit layer. The drive circuit layer may include multiple rows of pixel circuits 210 arranged in the column direction. The number of projections of winding lines in a first region is the same as the number of projections of winding lines in a second region. The first region and the second region are projection regions of two rows of pixel circuits 210 in the target region 25 on the substrate, respectively.

The number of projections of winding lines in the first region is the same as the number of projections of winding lines in the second region, so that the distribution of winding lines in the winding line region 24 is uniform, reducing the mura (display non-uniformity) problem caused by uneven distribution of winding lines in the winding line region 24.

Based on the above embodiments, as shown in FIG. 6, in one example, the threshold compensation module 2101 may include a threshold compensation transistor T2, the first initialization module 2102 may include a first initialization transistor T1, the data writing module 2103 may include a data writing transistor T4, the second initialization module 2104 may include a second initialization transistor T7, the third initialization module 2105 may include a third initialization transistor T8, the first light emission control module 2106 may include a first light emission control transistor T5, and the second light emission control module 2107 may include a second light emission control transistor T6.

The pixel circuit 210 may include a drive transistor T3, a storage capacitor Cst, a threshold compensation transistor T2, a first initialization transistor T1, a data writing transistor T4, a second initialization transistor T7, a third initialization transistor T8, a first light emission control transistor T5, and a second light emission control transistor T6.

The drive transistor T3 is configured to provide a drive current to a light-emitting element.

A first terminal of the storage capacitor Cst is configured to receive the first power signal, and a second terminal of the storage capacitor Cst is connected to the gate of the drive transistor T3.

A first electrode of the threshold compensation transistor T2 is connected to the second electrode of the drive transistor T3, a second electrode of the threshold compensation transistor T2 is connected to the gate of the drive transistor T3, a gate of the threshold compensation transistor T2 is connected to the second signal transmission line, and the gate of the threshold compensation transistor T2 is configured to receive the first scan signal.

A first electrode of the first initialization transistor T1 is configured to receive the first initialization signal, a second electrode of the first initialization transistor T1 is connected to the gate of the drive transistor T3, a gate of the first initialization transistor T1 is connected to the first signal transmission line 211, and the gate of the first initialization transistor T1 is configured to receive the second scan signal.

A first electrode of the data writing transistor T4 is configured to receive the data signal, a second electrode of the data writing transistor T4 is connected to the first electrode of the drive transistor T3, and a gate of the data writing transistor T4 is configured to receive the third scan signal.

A first electrode of the second initialization transistor T7 is configured to receive the second initialization signal, a second electrode of the second initialization transistor T7 is connected to the gate of the drive transistor T3, and a gate of the second initialization transistor T7 is configured to receive the fourth scan signal.

A first electrode of the third initialization transistor T8 is configured to receive the third initialization signal, a second electrode of the third initialization transistor T8 is connected to the first electrode of the drive transistor T3, and a gate of the third initialization transistor T8 is configured to receive the fourth scan signal.

A first electrode of the first light emission control transistor T5 is configured to receive the first power signal, a second electrode of the first light emission control transistor T5 is connected to the first electrode of the drive transistor T3, and a gate of the first light emission control transistor T5 is configured to receive the light emission control signal.

A first electrode of the second light emission control transistor T6 is connected to the second electrode of the drive transistor T3, a second electrode of the second light emission control transistor T6 is connected to the anode of the light-emitting element, and a gate of the second light emission control transistor T6 is configured to receive the light emission control signal.

Based on the above embodiments, as shown in FIG. 7, in another example, the pixel circuit 210 may include a drive transistor T3, a storage capacitor Cst, a threshold compensation transistor T2, a first initialization transistor T1, a data writing transistor T4, a second initialization transistor T7, a third initialization transistor T8, a first light emission control transistor T5, and a second light emission control transistor T6.

The drive transistor T3 is configured to provide a drive current to a light-emitting element.

A first terminal of the storage capacitor Cst is configured to receive the first power signal, and a second terminal of the storage capacitor Cst is connected to the gate of the drive transistor T3.

A first electrode of the threshold compensation transistor T2 is connected to the second electrode of the drive transistor T3, a second electrode of the threshold compensation transistor T2 is connected to the gate of the drive transistor T3, a gate of the threshold compensation transistor T2 is connected to the second signal transmission line, and the gate of the threshold compensation transistor T2 is configured to receive the first scan signal.

A first electrode of the first initialization transistor T1 is configured to receive the first initialization signal, a second electrode of the first initialization transistor T1 is connected to the first electrode of the threshold compensation transistor T2, a gate of the first initialization transistor T1 is connected to the first signal transmission line 211, and the gate of the first initialization transistor T1 is configured to receive the second scan signal.

A first electrode of the data writing transistor T4 is configured to receive the data signal, a second electrode of the data writing transistor T4 is connected to the first electrode of the drive transistor T3, and a gate of the data writing transistor T4 is configured to receive the third scan signal.

A first electrode of the second initialization transistor T7 is configured to receive the second initialization signal, a second electrode of the second initialization transistor T7 is connected to the gate of the drive transistor T3, and a gate of the second initialization transistor T7 is configured to receive the fourth scan signal.

A first electrode of the third initialization transistor T8 is configured to receive the third initialization signal, a second electrode of the third initialization transistor T8 is connected to the first electrode of the drive transistor T3, and a gate of the third initialization transistor T8 is configured to receive the fourth scan signal.

A first electrode of the first light emission control transistor T5 is configured to receive the first power signal, a second electrode of the first light emission control transistor T5 is connected to the first electrode of the drive transistor T3, and a gate of the first light emission control transistor T5 is configured to receive the light emission control signal.

A first electrode of the second light emission control transistor T6 is connected to the second electrode of the drive transistor T3, a second electrode of the second light emission control transistor T6 is connected to the anode of the light-emitting element, and a gate of the second light emission control transistor T6 is configured to receive the light emission control signal.

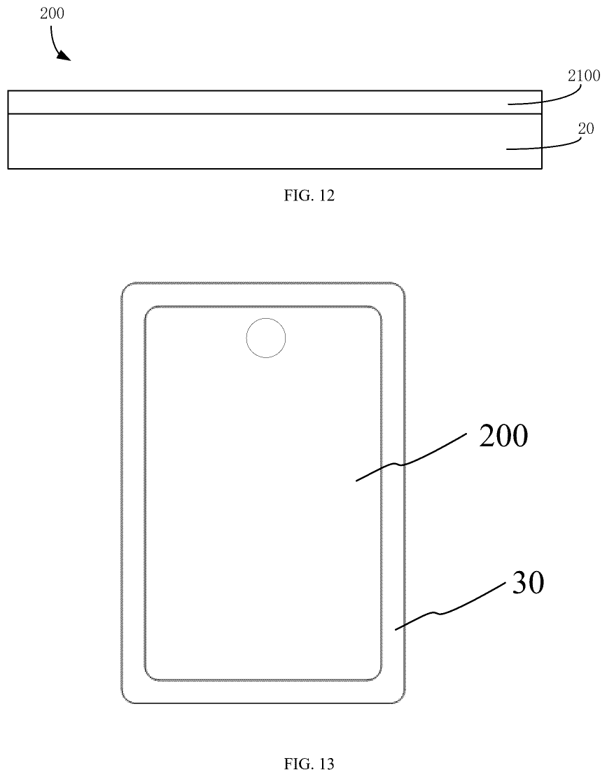

FIG. 12 is a structural, schematic view of a display screen according to some embodiments of the present disclosure. Some embodiments of the present disclosure provide a display screen 200. As shown in FIG. 12, the display screen 200 may include a cover plate 2100 and any display panel 20 provided in the foregoing embodiments. The cover plate 2100 may be arranged on the light-emitting side of the display panel 20 to protect the display panel 20.

Based on the same application concept, some embodiments of the present disclosure provide an electronic device. FIG. 13 is a structural, schematic view of an electronic device according to some embodiments of the present disclosure. As shown in FIG. 13, the electronic device 30 may include the display screen 200 described above. Since the display screen 200 includes the cover plate 2100 and the display panel 20 provided in the foregoing embodiments, the electronic device 30 has the technical effects of the display panel 20 described in the foregoing embodiments. The same parts may be understood with reference to the explanation of the display panel 20 above, and will not be repeated below.

The electronic device 30 provided by some embodiments of the present disclosure may be a mobile phone as shown in FIG. 13, or any electronic product with a display function, including but not limited to the following categories: a television, a notebook computer, a desktop monitor, a tablet computer, a digital camera, a smart bracelet, smart glasses, a vehicle-mounted display, an industrial control device, a medical display screen, or a touch interaction terminal, etc., which is not limited in the embodiments of the present disclosure.

The technical features in the above embodiments may be combined arbitrarily. For the sake of brevity, not all possible combinations of the technical features in the above embodiments are described. However, as long as there is no contradiction in the combination of these technical features, they should be considered as the scope described in this description.

The above embodiments only express several implementations of the present disclosure, and the description thereof is specific and detailed, but should not be understood as limiting the scope of the present disclosure. It should be pointed out that for those skilled in the art, without departing from the concept of the present disclosure, several modifications and improvements May be made, which all fall within the scope of the present disclosure. Therefore, the scope of the present disclosure shall be subject to the appended claims.

1. A display panel, comprising:
a hole region, a winding line region, a display region, and a non-display region; wherein the winding line region surrounds the hole region, and the display region surrounds at least part of the winding line region; the display panel further comprises a first gate drive circuit, and the first gate drive circuit is located in the non-display region on one side of the display region;
wherein the first gate drive circuit comprises a plurality of first gate drive units cascaded;
wherein each of the plurality of first gate drive units provides a first scan signal to two adjacent rows of a plurality of pixel circuits via two of a plurality of first signal transmission lines, respectively, and the first scan signal is capable of affecting gate potentials of drive transistors in the plurality of pixel circuits;
wherein a portion of each of the plurality of first signal transmission lines is located in the winding line region to form portions of the plurality of first signal transmission lines, and the portions of the plurality of first signal transmission lines located in the winding line region are independent of each other.

2. The display panel as claimed in claim 1, wherein each of the plurality of first signal transmission lines comprises a first A line segment, a first winding line, and a first B line segment electrically connected in sequence; the first winding line is located in the winding line region, the first A line segment is located in the display region on one side of the winding line region, and the first B line segment is located in the display region on another side of the winding line region.

3. The display panel as claimed in claim 1, further comprising a second gate drive circuit; wherein the second gate drive circuit is located in the non-display region on another side of the display region, and the second gate drive circuit comprises a plurality of second gate drive units cascaded;
wherein each of the plurality of second gate drive units of a same level as one of the plurality of first gate drive units provides a second scan signal to the two adjacent rows of the plurality of pixel circuits via two of a plurality of second signal transmission lines, respectively; the second scan signal is different from the first scan signal, and the second scan signal is capable of affecting the gate potentials of the drive transistors in the plurality of pixel circuits; a portion of each of the plurality of second signal transmission lines is located in the winding line region to form portions of the plurality of second signal transmission lines, and the portions of the plurality of second signal transmission lines located in the winding line region are independent of each other.

4. The display panel as claimed in claim 3, wherein each of the plurality of second signal transmission lines comprises a second A line segment, a second winding line, and a second B line segment electrically connected in sequence; the second winding line is located in the winding line region, the second A line segment is located in the display region on one side of the winding line region, and the second B line segment is located in the display region on another side of the winding line region; or
wherein the portions of the plurality of first signal transmission lines located in the winding line region are located in a different layer from the portions of the plurality of second signal transmission lines located in the winding line region.

5. The display panel as claimed in claim 1, further comprising:
a third gate drive circuit, comprising a plurality of third A gate drive units cascaded and a plurality of third B gate drive units cascaded; wherein the plurality of third A gate drive units are located in the non-display region on one side of the display region, and the plurality of third B gate drive units are located in the non-display region on another side of the display region;
wherein each of the plurality of third A gate drive units and one of the plurality of third B gate drive units set at a same level provide a third scan signal to a same row of the plurality of pixel circuits via one of a plurality of third signal transmission lines, and the third scan signal is capable of affecting data writing of the plurality of pixel circuits.

6. The display panel as claimed in claim 5, wherein each of the plurality of third signal transmission lines comprises a third A line segment connected to one of the plurality of third A gate drive units and a third B line segment connected to one of the plurality of third B gate drive units, the third A line segment and the third B line segment are connected to each other, the third A line segment is located in the display region on one side of the winding line region, and the third B line segment is located in the display region on another side of the winding line region; or
wherein each of the plurality of third signal transmission lines comprises a third A line segment, a third winding line, and a third B line segment electrically connected in sequence, the third A line segment is located in the display region on one side of the winding line region, the third B line segment is located in the display region on another side of the winding line region, and the third winding line is located in the winding line region.

7. The display panel as claimed in claim 5, wherein the portions of the plurality of first signal transmission lines located in the winding line region are located in a different layer from portions of the plurality of third signal transmission lines located in the winding line region; or
wherein portions of the plurality of third signal transmission lines located in the winding line region are located a same layer as portions of a plurality of second signal transmission lines located in the winding line region;
wherein the plurality of second signal transmission lines are configured to transmit a second scan signal, and the second scan signal is capable of affecting gate potentials of drive transistors in the plurality of pixel circuits.

8. The display panel as claimed in claim 1, wherein the non-display region comprises:
a fourth gate drive circuit, comprising a plurality of fourth gate drive units cascaded;
wherein each of the plurality of fourth gate drive units provides a fourth scan signal to two rows of the plurality of pixel circuits via two of a plurality of fourth signal transmission lines, respectively; the fourth scan signal is capable of affecting first electrode potentials of the drive transistors in the plurality of pixel circuits and anode potentials of light-emitting elements.

9. The display panel as claimed in claim 8, wherein each of the two of the plurality of fourth signal transmission lines comprises a fourth A line segment and a fourth B line segment, and one of the two of the plurality of fourth signal transmission lines comprises one fourth winding line; two fourth A line segments are respectively connected to two fourth B line segments via the one fourth winding line; the one fourth winding line is located in the winding line region, the fourth A line segments are located in the display region on one side of the winding line region, and the fourth B line segments are located in the display region on another side of the winding line region.

10. The display panel as claimed in claim 9, wherein one of a second winding line and a first winding line is located in a same layer as the fourth winding line, and another of the second winding line and the first winding line is located in a different layer from the fourth winding line;
wherein the first winding line is the portion of each of the plurality of first signal transmission lines located in the winding line region;
wherein the second winding line is a portion of each of the plurality of second signal transmission lines located in the winding line region, the plurality of second signal transmission lines are configured to transmit a second scan signal, and the second scan signal is capable of affecting the gate potentials of the drive transistors in the plurality of pixel circuits.

11. The display panel as claimed in claim 1, wherein the non-display region comprises:
a fifth gate drive circuit, comprising a plurality of fifth gate drive units cascaded;
wherein each of the plurality of fifth gate drive units provides a light emission control signal to two rows of the plurality of pixel circuits via two of a plurality of fifth signal transmission lines, respectively; the light emission control signal is capable of affecting light emission of light-emitting elements.

12. The display panel as claimed in claim 11, wherein each of the two of the plurality of fifth signal transmission lines comprises a fifth A line segment and a fifth B line segment, and one of the two of the plurality of fifth signal transmission lines comprises one fifth winding line; two fifth A line segments are respectively connected to two fifth B line segments via the one fifth winding line, the one fifth winding line is located in the winding line region, the fifth A line segments are located in the display region on one side of the winding line region, and the fifth B line segments are located in the display region on another side of the winding line region.

13. The display panel as claimed in claim 11, wherein the fifth gate drive circuit and a second gate drive circuit are located in the non-display region on a same side of the display region, and the second gate drive circuit is configured to provide a second scan signal, and the second scan signal is capable of affecting the gate potentials of the drive transistors in the plurality of pixel circuits; or
wherein one of a second winding line and a first winding line is located in a same layer as the fifth winding line, and another of the second winding line and the first winding line is located in a different layer from the fifth winding line; the first winding line is the portion of each of the plurality of first signal transmission lines located in the winding line region, and the second winding line is a portion of each of the plurality of second signal transmission lines located in the winding line region.

14. The display panel as claimed in claim 1, further comprising:
a substrate; and
a drive circuit layer, comprising a first gate layer and a second gate layer;
wherein the portion of each of the plurality of first signal transmission lines located in the winding line region is located in the second gate layer, and a portion of each of a plurality of second signal transmission lines located in the winding line region is located in the first gate layer.

15. The display panel as claimed in claim 14, wherein each of a plurality of third signal transmission lines comprises a third A line segment and a third B line segment connected in sequence, the third A line segment is located in the display region on one side of the winding line region, and the third B line segment is located in the display region on another side of the winding line region, the plurality of third signal transmission lines are configured to transmit a third scan signal, and the third scan signal is capable of affecting data writing of the plurality of pixel circuits;
wherein one of a fourth winding line and a fifth winding line is located in the first gate layer, and another of the fourth winding line and the fifth winding line is located in the second gate layer;
wherein the fourth winding line is a portion of each of the plurality of fourth signal transmission lines located in the winding line region, the plurality of fourth signal transmission lines are configured to transmit a fourth scan signal, and the fourth scan signal is capable of affecting first electrode potentials of the drive transistors in the plurality of pixel circuits and anode potentials of light-emitting elements;
wherein the fifth winding line is a portion of each of the plurality of fifth signal transmission lines located in the winding line region, the plurality of fifth signal transmission lines are configured to transmit a light emission control signal; or
wherein each of a plurality of third signal transmission lines comprises a third A line segment, a third winding line, and a third B line segment electrically connected in sequence; the plurality of third signal transmission lines are configured to transmit a third scan signal, and the third scan signal is capable of affecting data writing of the plurality of pixel circuits;
wherein a second winding line and a third winding line are located in the first gate layer, and a first winding line, a fourth winding line, and a fifth winding line are located in the second gate layer;
wherein the first winding line is the portion of each of the plurality of first signal transmission lines located in the winding line region;
wherein the second winding line is a portion of each of a plurality of second signal transmission lines located in the winding line region, the plurality of second signal transmission lines are configured to transmit a second scan signal, and the second scan signal is capable of affecting the gate potentials of the drive transistors in the plurality of pixel circuits;
wherein the third winding line is a portion of each of a plurality of third signal transmission lines located in the winding line region;
wherein the fourth winding line is a portion of each of a plurality of fourth signal transmission lines located in the winding line region, the plurality of fourth signal transmission lines are configured to transmit a fourth scan signal, and the fourth scan signal is capable of affecting first electrode potentials of the drive transistors in the plurality of pixel circuits and anode potentials of light-emitting elements;
wherein the fifth winding line is a portion of each of a plurality of fifth signal transmission lines located in the winding line region, the plurality of fifth signal transmission lines are configured to transmit a light emission control signal.

16. The display panel as claimed in claim 1, further comprising a substrate and a drive circuit layer; wherein the drive circuit layer comprises a plurality of rows of the plurality of pixel circuits arranged in a column direction, a number of projections of winding lines in a first region is the same as a number of projections of winding lines in a second region, the first region are projection regions of one of two rows of the plurality of pixel circuits in a target region on the substrate, and the second region are projection regions of another of the two rows of the plurality of pixel circuits in the target region on the substrate.

17. The display panel as claimed in claim 16, wherein each of the plurality of pixel circuits comprises:
a drive transistor, configured to provide a drive current to a light-emitting element;
a storage capacitor, wherein a first terminal of the storage capacitor is configured to receive a first power signal, a second terminal of the storage capacitor is connected to a gate of the drive transistor;
a threshold compensation module, wherein a first terminal of the threshold compensation module is connected to a second electrode of the drive transistor, a second terminal of the threshold compensation module is connected to the gate of the drive transistor, a control terminal of the threshold compensation module is configured to receive the first scan signal; and
a first initialization module, wherein a first terminal of the first initialization module is configured to receive a first initialization signal, a second terminal of the first initialization module is connected to the gate of the drive transistor, a control terminal of the first initialization module is configured to receive a second scan signal; or
wherein each of the plurality of pixel circuits comprises:
a drive transistor, configured to provide a drive current to a light-emitting element;
a storage capacitor, wherein a first terminal of the storage capacitor is configured to receive a first power signal, a second terminal of the storage capacitor is connected to a gate of the drive transistor;
a threshold compensation module, wherein a first terminal of the threshold compensation module is connected to a second electrode of the drive transistor, a second terminal of the threshold compensation module is connected to the gate of the drive transistor, a control terminal of the threshold compensation module is configured to receive the first scan signal; and
a first initialization module, wherein a first terminal of the first initialization module is configured to receive a first initialization signal, a second terminal of the first initialization module connected to the first terminal of the threshold compensation module, a control terminal of the first initialization module is configured to receive a second scan signal.

18. The display panel as claimed in claim 17, wherein each of the plurality of the pixel circuits comprises:
a data writing module, wherein a first terminal of the data writing module is configured to receive a data signal, a second terminal of the data writing module connected to a first electrode of the drive transistor, a control terminal of the data writing module is configured to receive a third scan signal;
a second initialization module, wherein a first terminal of the second initialization module is configured to receive a second initialization signal, a second terminal of the second initialization module connected to the gate of the drive transistor, a control terminal of the second initialization module is configured to receive a fourth scan signal;
a third initialization module, wherein a first terminal of the third initialization module is configured to receive a third initialization signal, a second terminal of the third initialization module connected to a first electrode of the drive transistor, a control terminal of the third initialization module is configured to receive a fourth scan signal;
a first light emission control module, wherein a first terminal of the first light emission control module is configured to receive a first power signal, a second terminal of the first light emission control module is connected to the first electrode of the drive transistor, a control terminal of the first light emission control module is configured to receive a light emission control signal; and
a second light emission control module, wherein a first terminal of the second light emission control module connected to the second electrode of the drive transistor, a second terminal of the second light emission control module connected to an anode of the light-emitting element, a control terminal of the second light emission control module is configured to receive a light emission control signal.

19. A display screen, comprising:
a cover plate and a display panel;
wherein the display panel comprises: a hole region, a winding line region, a display region, and a non-display region; the winding line region surrounds the hole region, and the display region surrounds at least part of the winding line region; the display panel further comprises a first gate drive circuit, and the first gate drive circuit is located in the non-display region on one side of the display region;
wherein the first gate drive circuit comprises a plurality of first gate drive units;
wherein each of the plurality of first gate drive units provides a first scan signal to two adjacent rows of a plurality of pixel circuits via two of a plurality of first signal transmission lines, respectively, and the first scan signal is capable of affecting gate potentials of drive transistors in the plurality of pixel circuits;
wherein a portion of each of the plurality of first signal transmission lines is located in the winding line region to form portions of the plurality of first signal transmission lines, and the portions of the plurality of first signal transmission lines located in the winding line region are independent of each other.

20. An electronic device, comprising:
a display screen;
wherein the display screen comprises a cover plate and a display panel;
wherein the display panel comprises: a hole region, a winding line region, a display region, and a non-display region; the winding line region surrounds the hole region, and the display region surrounds at least part of the winding line region; the display panel further comprises a first gate drive circuit, and the first gate drive circuit is located in the non-display region on one side of the display region;
wherein the first gate drive circuit comprises a plurality of first gate drive units;
wherein each of the plurality of first gate drive units provides a first scan signal to two adjacent rows of a plurality of pixel circuits via two of a plurality of first signal transmission lines, respectively, and the first scan signal is capable of affecting gate potentials of drive transistors in the plurality of pixel circuits;
wherein a portion of each of the plurality of first signal transmission lines is located in the winding line region to form portions of the plurality of first signal transmission lines, and the portions of the plurality of first signal transmission lines located in the winding line region are independent of each other.
